(19) United States
(12) Patent Application Publication
(10) Pub. No.: US 2006/0097006 A1
(43) Pub. Date: May 11, 2006

(54) Pour spout fitment with internal cut off

(75) Inventor: Robert J. Smith, Edinboro, PA (US)

Correspondence Address: BLYNN L. SHIDELER;THE BLK LAW GROUP, 3500 BROKKTREE ROAD, SUITE 200, WEXFORD, PA, 15090, US

(73) Assignee: Erie County Plastics Corporation, Corry, PA (US)

(21) Appl. No.: 11/248,011

(22) Filed: Oct. 11, 2005

(51) Int. Cl. B67D 1/16

(52) U.S. Cl. 222/109

(57) ABSTRACT

A drip-less one-piece, injection molded pour spout fitment includes an annular skirt having an attaching mechanism for coupling to a neck finish of a container. The fitment includes a tapered pour spout defining a pour channel that is in fluid communication with the container when the fitment is attached thereto to allow for dispensing container contents through container tilting, whereby the contents flow through the pour channel in a conventional fashion. The fitment includes an internal, flow cut-off projection extending across the pour channel and in a radial inward direction from the pour channel, from a location spaced from the pour spout distal end, whereby the projection will prevent flow at a cut-off angle of tilt at which the contents would continue flow through the pour channel in the absence of the cut-off projection. A neck finish pour spout with internal cut off is also disclosed.

### BACKGROUND OF THE INVENTION

1. Field of the Invention

The present invention relates to pour spouts with drip-less features and more specifically to drain-back, pour spout fitment for containers with drip-less features.

2. Background of the Invention

Drain-back pour spouts are very well known in the art. One class of drain back pour spouts forms the spout as a fitment attached to a separate container with a separate closure for the fitment. One subset of this class is those devices having the closure, or cap, attached to the bottle and another subset is having the cap attached to the fitment or pour spout. A second class of drain-back pour spouts is one in which the spout is formed integral with the container, in other words the spout forms a specialized finish (e.g. neck finish) for the container. In this class the closure is always connected directly to the container since there is no separate fitment. A review of the representative prior art will further clarify the state of the art.

U.S. Pat. Nos. 6,464,106 and 6,431,401, both assigned to Lever Brothers Company, disclose a drain back converging nozzle spout fitment secured to a container opening with an external ridge engaging an internal ring on the container. A closure or cap is threaded onto the container over the fitment to close the container opening.

U.S. Pat. No. 6,398,076, assigned to Unilever Home & Personal Care USA, discloses a variety of drain back, snap on, cylindrical nozzle, pour spout fitments with inside of the spout (also called the gutter or apron) not extending below outer connecting flange of the fitment.

U.S. Pat. No. 6,375,041 discloses a container with an integral (or separate) drain back, converging nozzle neck finish (or fitment if it is separate) with a cap or closure threaded onto the spout portion, wherein the cap includes a reservoir for holding a concentrated product, e.g. detergent. If separate he fitment would be apparently press fit or welded to the container opening.

U.S. Pat. No. 6,279,789, assigned to Owens-Brockway Plastics Products, Inc., discloses a variety of spout (both integral with the container and as separate fitments) and closure configurations with the cap or closure including a disk with a metallic under-layer for induction welding to associated structure. One embodiment shown in FIG. 3 includes a fitment secured within the container finish with the cap threaded to the fitment with internal threads on the fitment.

U.S. Pat. No. 6,223,946, assigned to Owens-Illinois Closures, Inc., discloses a bottle with integral drain back spout and closure configuration with threads formed on the neck of the bottle engaging the closure directly.

U.S. Pat. No. 6,223,945, assigned Lever Brothers Company, discloses a specific three layer bottle composition for the fitment and closure of U.S. Pat. No. 6,464,106 discussed above.

U.S. Pat. No. 6,209,762, assigned to Owens-Illinois Closures, Inc., discloses a bottle with snap in drain back spout configuration having a projecting lug and receiving slot for positioning of the fitment.

U.S. Pat. No. 6,123,231, assigned to Owens-Brockway Plastics Products, Inc., discloses a one piece bottle with integral drain back spout configuration.

U.S. Pat. No. 6,032,829, assigned to Owens-Illinois Closures, Inc., discloses a bottle with integral spout and closure configuration with threads formed on the neck of the bottle engaging the closure directly.

U.S. Pat. No. 5,941,422, assigned to Owens-Brockway Plastics Products, Inc. discloses a bottle, drain back spout fitment and closure configuration with a unique bottle neck finish having a radial inwardly annular wall and an axial wall extending upwardly and away from the inner extending wall. The fitment has a depending apron extending over the neck finish and welded thereto.

U.S. Pat. No. 5,855,299, assigned to Graham Packaging Corporation, discloses a drain back spout fitment configuration with an inner radial outwardly facing annular bead engaging a shoulder of the bottle neck.

U.S. Pat. No. 5,794,803, assigned to Rexam Closures, Inc., discloses a drain back spout fitment configuration with a cap threaded onto threads of the bottle and with a child safety lock mechanism between the bottle and the cap, wherein the latch release on the cap is biased in a radial direction away from the bottle.

U.S. Pat. No. 5,603,787, assigned to Innovative Molding Inc., discloses a method of assembly of a bottle with a pour back spout configuration with an annular solid wall and the pour back feature being formed in an opening in the outer wall or trough. The method includes ultrasonic welding of the pour spout fitment to the container.

U.S. Pat. No. 5,597,090 discloses a spout fitment configuration with a “v” shaped notch at the terminal end. The cap is threaded to the bottle over the spout fitment.

U.S. Pat. Nos. 5,566,862 and 5,462,202, both assigned to Owens-Illinois Plastics Products, Inc. disclose a drain back spout fitment configurations with an annular solid wall and the pour back feature being formed in an extended opening in the outer wall. The closure is threaded onto the bottle over the fitment.

U.S. Pat. No. 5,431,306, assigned to Innovative Molding Inc., discloses a drain back spout fitment configuration with an annular top flange bonded to an upper end of the bottle neck finish. The closure is threaded to the fitment with external threads on the closure engaging internal threads on the fitment below a sealing portion therebetween.

U.S. Pat. No. 5,251,788, assigned to Phoenix Closures, Inc., discloses a bottle, drain back frusto-conical or converging nozzle spout fitment and cap configuration. The bottle includes a threaded neck to receive the threaded spout. The cap is threaded to an upper portion of the annular wall.

U.S. Pat. No. 5,234,130, assigned to Manhattan Products, discloses a bottle, drain back pour spout fitment and cap configuration. The bottle includes an internal neck finish recess to engage a retaining member on the spout and allow the cap to seal against the bottle finish.

U.S. Pat. No. 5,207,356, assigned to Owens-Illinois Plastics Products, Inc., discloses a bottle with an integral spout and cap configuration.

U.S. Pat. No. 5,131,566, assigned to Proctor & Gamble Company, discloses a package assembly with a “refill facilitating” drain back spout having piecing serrations on the spout. An associated closure is not disclosed.

U.S. Pat. No. 5,114,659, assigned to Owens-Illinois Plastic Products Inc., discloses a method of making a one piece bottle and integral drain back pour spout.

U.S. Pat. No. 5,108,009, assigned to Lever Brothers Company, discloses a bottle, drain back spout fitment and cap configuration with the cap screwed onto the container.

U.S. Pat. No. 5,058,772, assigned to Phoenix Closures, discloses a bottle, drain back pour spout fitment and cap configuration. The spout fitment is threaded to the bottle and includes external threads on an upper portion thereof for the cap to be threaded onto.

U.S. Pat. No. 4,993,605, assigned to Colgate Palmolive Co., discloses a bottle, drain back pour spout fitment and cap configuration wherein the cap engages the container (e.g. threaded bottle neck) to urge the spout fitment into sealing engagement with the neck finish.

U.S. Pat. No. 4,984,714 discloses a bottle, spout fitment and cap configuration with the cap threaded to the bottle.

U.S. Pat. No. 4,981,239, assigned to Proctor & Gamble Company, discloses a bottle with an integral spout and cap configuration.

U.S. Pat. No. 4,974,749, assigned to Colgate Palmolive Co., discloses a bottle, drain back pour spout fitment and cap configuration with a threaded bottle neck finish that the cap threads onto.

U.S. Pat. No. 4,917,270 discloses a bottle, drain back pour spout fitment and cap configuration with a threaded bottle neck finish that the cap threads onto.

U.S. Pat. No. 4,917,269, assigned to Owens-Illinois Plastics Products, Inc., discloses a bottle with an integral spout and cap configuration.

U.S. Pat. No. 4,917,268, assigned to The Clorox Company, discloses a bottle, drain back pour spout fitment and cap configuration with a special interlocking and centering feature between the bottle neck finish and the fitment. The cap is threaded onto the bottle.

U.S. Pat. No. 4,890,770 discloses a unique bottle spout and cap configuration with an inside drainage passage between the cap and the outside of the spout.

U.S. Pat. No. 4,863,067, assigned to Owens-Illinois Plastics Products, Inc. discloses a bottle with an integral spout and cap configuration.

U.S. Pat. No. 4,836,419 discloses a drain back spout fitment and cap configuration with a drain in the apron or floor portion adjacent the spout. The drain back opening has a blocking mechanism to selectively block the opening. The cap is threaded external threads on the fitment on an apron around the bottle opening.

U.S. Pat. No. 4,830,234 discloses a bottle, drain back pour spout fitment and cap configuration with a threaded bottle neck finish that the cap threads onto.

U.S. Pat. No. 4,773,560 discloses a bottle, drain back pour spout fitment and cap configuration with a threaded bottle neck finish that the cap threads onto.

U.S. Pat. No. 4,706,829, assigned to Owens-Illinois Closure, Inc., discloses a bottle, drain back pour spout fitment and cap configuration with a threaded bottle neck finish that the cap threads onto.

U.S. Pat. No. 4,696,416, assigned to Proctor & Gamble, discloses a bottle, a drain back spout fitment threaded to the container, and cap threaded to an upper portion of the fitment, with a drip accumulator structure extending down from the drain hole.

U.S. Pat. No. 4,671,421 discloses a bottle, drain back spout fitment and cap configuration with the spout fitment engaging the inner surface of the container interconnecting the spout fitment with the bottle.

U.S. Pat. Nos. 4,550,862, 4,128,189, 4,078,700, 3,369,710, 2,808,964, 2,763,403, 2,763,402, 2,743,844, and 2,601,040 also show a variety of drain back spout configurations similar to those discussed above.

The pour spout designs have also attempted to design spout configurations which minimize spillage on the outside of the spout. This is known as drip-less pour spout technology. One well known technique is to have particular curvature geometry on the distal end of the pour spout which minimizes the spillage. This geometry presents some difficulties in injection molded closures as it often extends beyond the end of the other elements of the pour spout requiring some specialty molding techniques or considerations which can increase the cost of the mold.

There remains a need in the art to provide a drip-less pour spout for containers which is economical to mold and provides the desired performance features, particularly where the pour spout is in a fitment. It is the object of the present invention to improve upon the prior art designs and to address this need.

### SUMMARY OF THE INVENTION

At least some of the above stated objects is achieved with a drip-less one-piece, injection molded pour spout fitment according to the present invention for attachment to a neck finish of a container. The term “drip-less” conveys a pour spout that includes a design element or configuration intended to minimize spillage in operation. The fitment includes an annular skirt having an attaching mechanism, such as a snap fit bead or a threads, for coupling the fitment to a neck finish of a container. The fitment includes at least a partially tapered pour spout coupled to the annular skirt. The term “tapered” in reference to the pour spout can be a tapering of the internal pour channel forming side in either, or both, side to side and front to back dimensions as described. The pour spout defines a pour channel on one side of the pour spout, wherein the pour channel is in fluid communication with the container when the fitment is attached thereto to allow for dispensing of the contents of the container through tilting of the container whereby the contents flow through the pour channel in a conventional fashion. The fitment includes an internal, flow cut-off projection extending in a radial inward direction from the pour channel, from a location spaced from the distal end of the pour spout and extending across the pour channel whereby the projection will prevent flow through the pour channel at a cut-off angle of tilt of the container wherein the contents would continue flow through the pour channel at the cut-off angle in the absence of the cut-off projection.

The one-piece, injection molded pour spout fitment of the present invention may include, in one non-limiting embodiment, an upper surface of the cut-off projection that is angled relative to horizontal when the fitment is on the container and the container is in a normal up-right resting position, whereby material above the cut-off as the container is placed into the resting position can flow back into the container. The cut-off projection may extend into the pour channel to a height that is greater than or equal to the thickness of the pour spout and less than or equal to the width of the pour channel; and the thickness of the cut-off projection at a distal end thereof may be less than the thickness of the pour spout. The pour spout may be substantially vertical at the position above the cut-off projection. The term “substantially vertical” is +/− one degree. The fitment may further include a closure attachment, such as external threads on the pour spout.

The one-piece, injection molded pour spout fitment of the present invention may include, in one non-limiting embodiment, a drain back channel formed adjacent and in a radial outward location from the pour spout, and further including a drain back opening, wherein an annular wall defines the drain back channel extending from the annular skirt.

The present invention is not limited to one-piece, injection molded pour spout fitments and may include, in one non-limiting embodiment, a pour spout with an internal, flow cut-off projection extending in a radial inward direction from the pour channel, from a location spaced from the distal end of the pour spout and extending across the pour channel whereby the projection will prevent flow through the pour channel at a cut-off angle of tilt of the container wherein the contents would continue flow through the pour channel at the cut-off angle in the absence of the cut-off projection, and wherein the contents will flow through the pour channel over the cut-off projection at angles greater than the cut-off angle; and wherein the pour spout is an integral molded neck finish of the container.

These and other advantages of the present invention will be clarified in the detailed description of the preferred embodiment taken together with the attached drawings.

### BRIEF DESCRIPTION OF THE DRAWINGS

FIG. 1 is a top perspective view of a one-piece, injection molded drain back pour spout fitment with internal flow cut-off according one aspect of the present invention;

FIG. 2 is a bottom perspective view of the pour spout fitment illustrated in FIG. 1;

FIG. 3 is a side elevation view of the fitment of FIGS. 1-2;

FIG. 4 is a top plan view of the fitment of FIGS. 1-2;

FIG. 5 is a bottom plan view of the fitment of FIGS. 1-2;

FIG. 6 is a side elevation section view of the fitment of FIGS. 1-2;

FIG. 7 is a rear elevation section view of the fitment of FIGS. 1-2;

FIG. 8 is an enlarges side elevation section view of the flow cut-off for the pour channel of the pour spout fitment of FIGS. 1-2;

FIG. 9 is a top perspective view of a one-piece, injection molded pour spout fitment with internal flow cut-off according one aspect of the present invention;

FIG. 10 is a bottom perspective view of the pour spout fitment illustrated in FIG. 9;

FIG. 11 is a side elevation view of the fitment of FIGS. 9-10;

FIG. 12 is a top plan view of the fitment of FIGS. 9-10;

FIG. 13 is a bottom plan view of the fitment of FIGS. 9-10;

FIG. 14 is a side elevation section view of the fitment of FIGS. 9-10; and

FIG. 15 is a side elevation section view of a molded pour spout container neck finish with internal flow cut-off according one aspect of the present invention.

### DESCRIPTION OF THE PREFERRED EMBODIMENTS

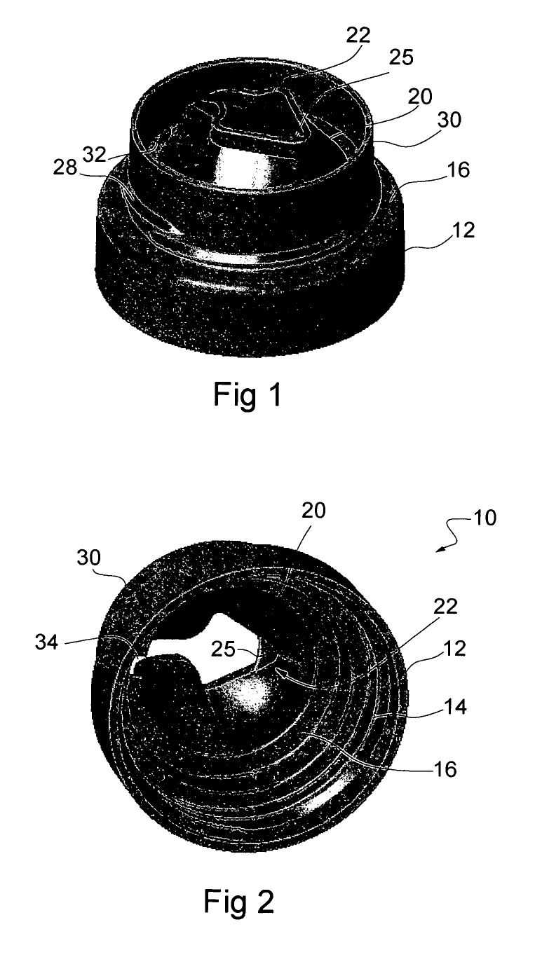

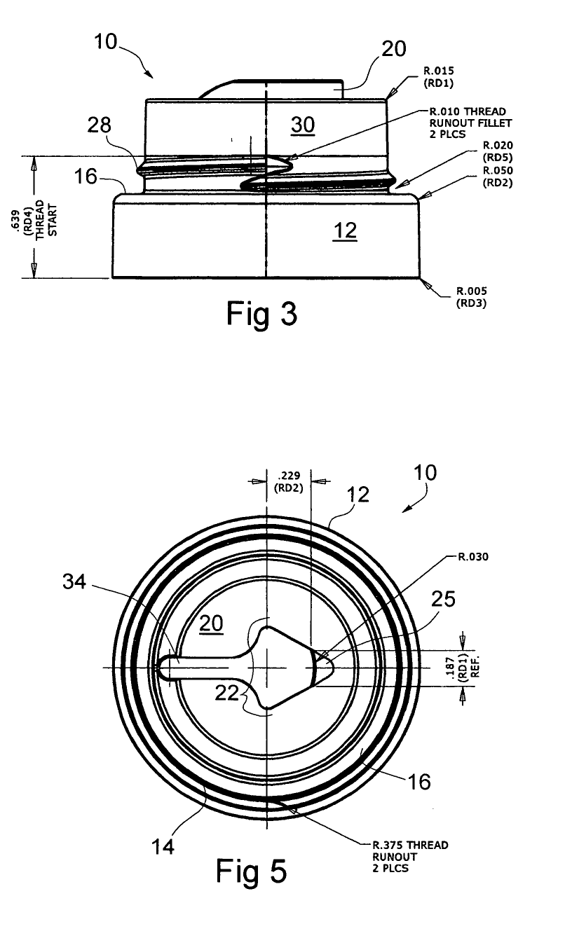

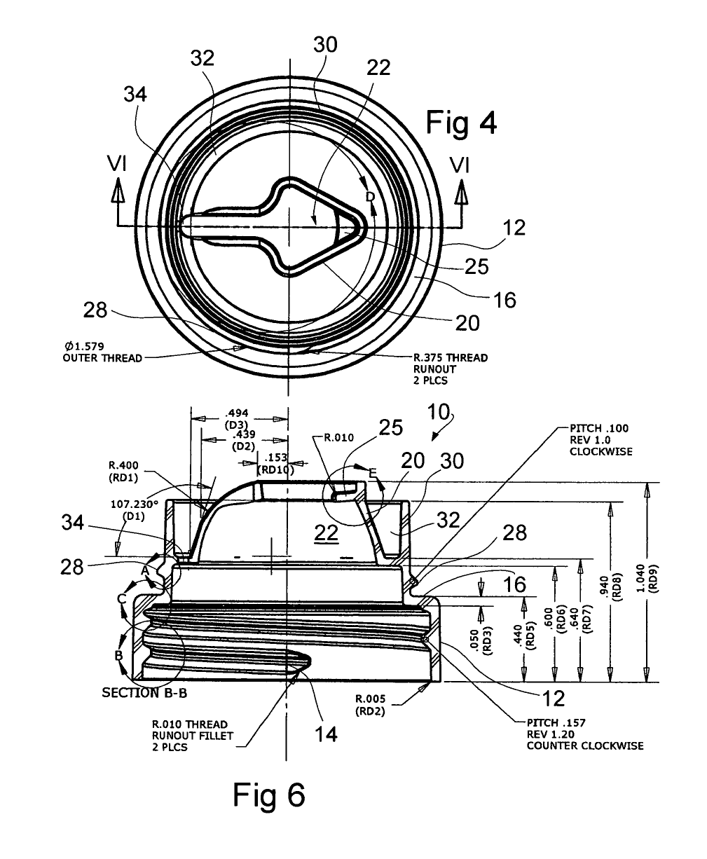

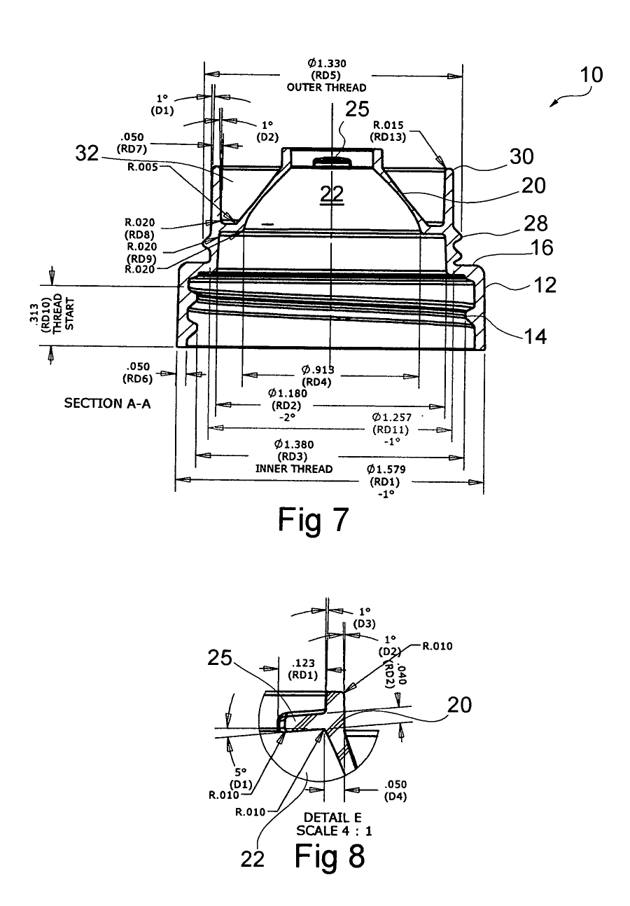

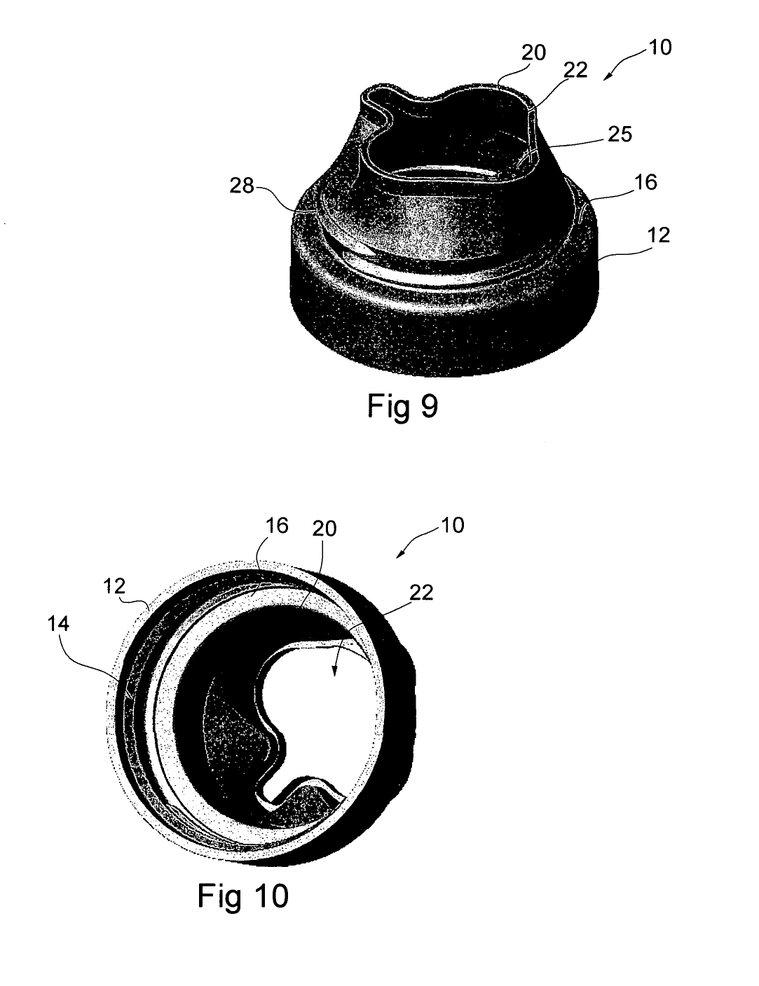

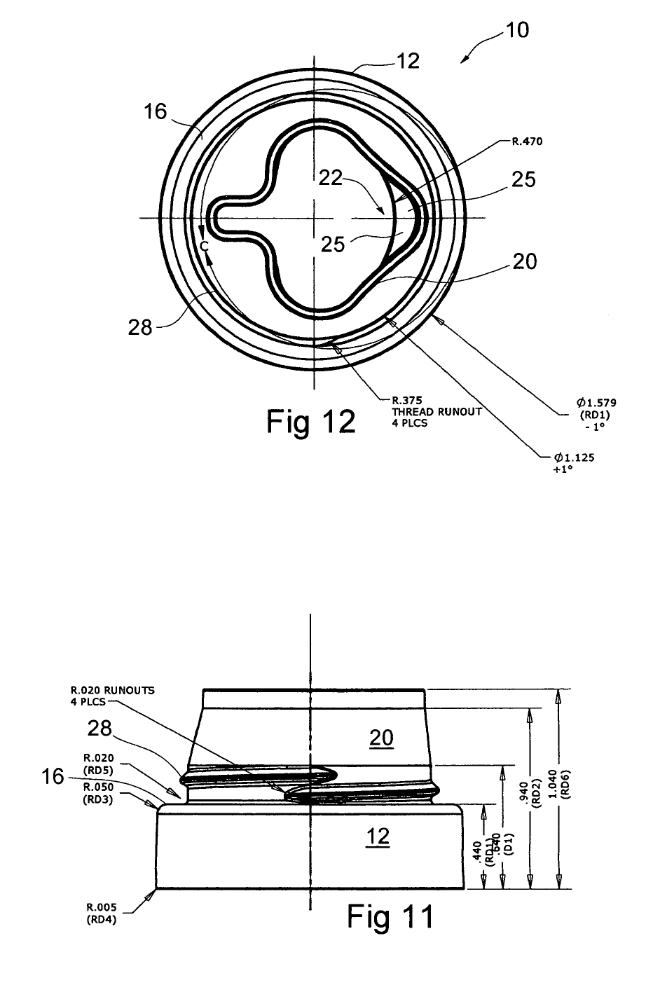

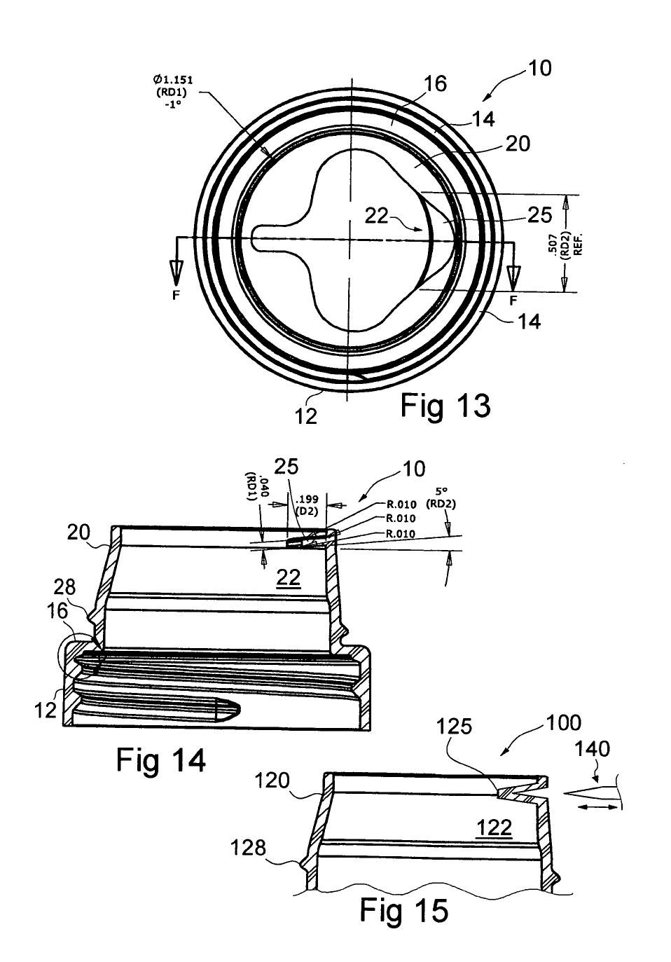

The present invention provides a drip-less one-piece, injection molded pour spout fitment 10 for attachment to a neck finish of a container (not shown) as shown in FIGS. 1-8 in one embodiment and FIGS. 9-14 in a second embodiment. As noted above, the term “drip-less” within the meaning of this application conveys a pour spout that includes a design element or configuration intended to minimize spillage in operation. The containers, such as bottles and the like, are well known in the art and generally include well known neck finish, such as external threads or a snap fit bead for receipt of the fitment 10. The container will have a standard or resting position, also considered the vertical position, wherein the contents remain within the interior of the container. Tipping of the container, with the fitment 10 attached and any closure removed there from, will allow the contents of the container (e.g. fluid) to be poured out, as is exceedingly well known.

The fitment 10 includes an annular skirt 12 having an attaching mechanism 14 on the interior thereof. The attaching mechanism 14 may be a snap fit bead or internal threads 14 (as shown), for coupling the fitment 12 to a corresponding neck finish of a container. The attaching mechanism 14 could also be external threads to correspond to internal threads of the container neck finish. It is the known geometry of the neck finish that defines the configuration of the attaching mechanism 14. However, threads 14, as shown, may represent the most common attachment for the fitment 10. Adjacent the annular skirt 12 is a shoulder 16, which can include internal sealing mechanism, such as a flange or the like, to provide a tight fluid seal against the container neck finish.

The fitment 10 includes at least a partially tapered pour spout 20 coupled to the annular skirt 12, through the shoulder 16. As noted above, the term “tapered” in reference to the pour spout 20 can be a tapering of the internal pour channel forming side in either, or both, side to side and front to back dimensions. Within the meaning of the present application, “vertical” will reference the direction center axis of the annular skirt 12, “horizontal” will reference perpendicular to the vertical dimension, the upper side references the pour spout 22 end of the fitment 10; the lower end will reference the skirt 12 end of the fitment 12, the back of the fitment 10 will reference the location of the drain back features (FIGS. 1-8), the front of the fitment 10 will reference the pour channel 22 of the fitment 20. These relative positions are given only for the purpose of more clearly explaining the fitment 10 and its operation, and not to be restrictive thereof. The pour spout 10 defines a pour channel 22 on one front side of the pour spout 10, wherein the pour channel 22 is in fluid communication with the container when the fitment 10 is attached thereto to allow for dispensing of the contents of the container through tilting of the container whereby the contents flow through the pour channel 22 in a conventional fashion.

The fitment 10 includes an internal, flow cut-off projection 25, shown in detail in FIG. 8, extending in a radial inward direction from the pour channel 22 to form an easily molded, effective drip-less feature for the fitment 10. The projection 25 is at a location spaced from the distal end of the pour spout 20 to form a receiving area for any liquid (or other dispensing contents of the container) that remains in the fitment 10 above the pour channel 22 when the flow is initially cut off by the projection 25. As easily viewed in the figures the projection extends across the pour channel 22. Consequently, the projection 25 will prevent flow through the pour channel 22 at a “cut-off angle of tilt” of the container wherein the contents would continue flow through the pour channel 22 at the cut-off angle in the absence of the cut-off projection 25. The “cut-off angle of tilt” will vary depending upon the amount of liquid in the container and the term is only used to help define the function of the fitment 10. As the container and attached fitment 10 is tilted, the contents will flow through the pour channel 22, over the projection 22, in a conventional fashion once the container is tilted past the “cut-off angle” associated the fitment 10, the projection 25 and starting level of contents (e.g. liquid) of the container. In order to cease flow of the contents the container is tilted back and the projection 25 will prematurely cut off the flow at an associated cut off angle (again this will of course be different from the angle at which flow began). The term prematurely is intended to convey that the flow will be cut off by the projection 25 at an angle greater (relative to vertical or at rest position) than if the projection 25 were not present in the fitment 12.

The one-piece, injection molded pour spout fitment 10 provides that an upper surface of the cut-off projection 25 is angled relative to horizontal when the fitment is on the container and the container is in a normal up-right resting position. In this fashion the container contents above the cut-off projection 25 as the container is placed into the resting position can flow back into the container. One non-limiting dimension for the projection 25 provides that the cut-off projection 25 may extend into the pour channel 22 to a height (i.e. the dimension perpendicular to the pour spout 20) that is greater than or equal to the thickness of the pour spout 20 (i.e. wall thickness) and less than or equal to the width of the pour channel 20 (measured side to side at the end of the pour spout 20). Another non limiting dimension for the projection is that the thickness of the cut-off projection 25 at a distal end thereof may be less than the thickness of the pour spout 20. This provides a thin or sharp projection 25 (at least at the end), which is believed to be helpful in abruptly stopping flow further assisting in the minimizing of drips. The pour spout 20 may be substantially vertical at the position above the cut-off projection, wherein the term “substantially vertical” is +/− one degree. This construction allows for simple molding configurations and associated decreased costs.

The fitment 10 further include a closure attachment 28, such as external threads on the pour spout 20. The closure attachment allows for receipt of an associated cap (not shown), the construction of which will be well known to those of ordinary skill in the art. The fitment 10 and associated cap will form a closure fitment assemble for the associated container. It is expected that the associated cap will also be a one piece injection molded structure as is common in the art.

The one-piece, injection molded pour spout fitment 10 of the present invention shown in FIGS. 1-8, is one non-limiting embodiment of the invention and includes an annular wall 30 defining a drain back channel 32 formed adjacent and in a radial outward location from the pour spout 20. The fitment 10 of FIGS. 1-8 further includes a drain back opening 34 opposite the pour channel 22 at the back of the fitment 20. This drain back construction allows for material that does spill beyond the pour spout 20, despite the cut off projection 25, to flow back into the container 20. The projection 25 of the present invention is intended to minimize need for and use of the outer drain back features. Consequently the fitment 10 shown in FIGS. 9-14 eliminates the second drain back elements formed by wall 30, channel 32 and opening 34. The downward sloping of the upper side of projection 25 is a first drain back feature, such that even the fitment 10 of FIGS. 9-14 can be considered a drain back pour spout since this forms a drain back feature for contents above the projection 25 at the time of cutting off of the flow. It would be expected that the fitment 10 of FIGS. 1-8 may be more desirable for more viscous materials (e.g. maple syrup), while the fitment 10 of FIGS. 9-14 suitable for less viscous materials.

The present invention is not limited to one-piece, injection molded pour spout fitments and may include, in one non-limiting embodiment, a neck finish 100 itself. FIG. 15 illustrates a pour spout 120 with an internal, flow cut-off projection 125 extending in a radial inward direction from the pour channel 122, from a location spaced from the distal end of the pour spout 120 and extending across the pour channel 122 whereby the projection 125 will prevent flow through the pour channel 122 at a cut-off angle of tilt of the container wherein the contents would continue flow through the pour channel 122 at the cut-off angle in the absence of the cut-off projection 125, and wherein the contents will flow through the pour channel 122 over the cut-off projection 125 at angles greater than the cut-off angle. The pour spout 120 is essentially the same as pour spout 20 discussed above such as including external threads 128 for cap attachment, however the pour spout 120 is an integral molded neck finish 100 of the container. In forming the neck finish 100 with pour spout 125 it is likely easier to use a reciprocating projection forming member 140 rather than forming the internal rib as shown in FIGS. 1-14. Other design considerations when molding the neck finish 100 will be apparent to those of ordinary skill in the art, such as limitations on the effective tapering of the pour spout 120, but FIG. 15 is intended only to be representative of the present invention.

The above described embodiment is intended to be merely illustrative of the present invention and not restrictive thereof. The scope of the present invention is intended to be defined by the appended claims and equivalents thereof.

What is claimed is:

1. A one-piece, injection molded pour spout fitment for attachment to a neck finish of a container comprising:
An annular skirt having an attaching mechanism for coupling the fitment to a neck finish of a container;
At least a partially tapered pour spout coupled to the annular skirt, wherein the pour spout defines a pour channel on one side of the pour spout, wherein the pour channel is in fluid communication with the container when the fitment is attached thereto to allow for dispensing of the contents of the container through tilting of the container whereby the contents flow through the pour channel; and
An internal, flow cut-off projection extending in a radial inward direction from the pour channel, from a location spaced from the distal end of the pour spout and extending across the pour channel whereby the projection will prevent flow through the pour channel at a cut-off angle of tilt of the container wherein the contents would continue flow through the pour channel at the cut-off angle in the absence of the cut-off projection.

2. The one-piece, injection molded pour spout fitment of claim 1 wherein an upper surface of the cut-off projection is angled relative to horizontal when the fitment is on the container and the container is in a normal up-right resting position, whereby material above the cut-off as the container is placed into the resting position can flow back into the container.

3. The one-piece, injection molded pour spout fitment of claim 1 wherein the cut-off projection extends into the pour channel to a height that is greater than or equal to the thickness of the pour spout and less than or equal to the width of the pour channel.

4. The one-piece, injection molded pour spout fitment of claim 1 wherein the thickness of the cut-off projection at a distal end thereof is less than the thickness of the pour spout.

5. The one-piece, injection molded pour spout fitment of claim 1 wherein the pour spout is substantially vertical at the position above the cut-off projection.

6. The one-piece, injection molded pour spout fitment of claim 1 further including a closure attachment on the pour spout.

7. The one-piece, injection molded pour spout fitment of claim 1 further including a drain back channel formed adjacent and in a radial outward location from the pour spout, and further including a drain back opening.

8. The one-piece, injection molded pour spout fitment of claim 7 further including an annular wall defining the drain back channel extending from the annular skirt.

9. A molded pour spout fitment for a container comprising:
At least a partially tapered pour spout that defines a pour channel on one side of the pour spout, wherein the pour channel is in fluid communication with the container to allow for dispensing of the contents of the container through tilting of the container whereby the contents flow through the pour channel; and
An internal, flow cut-off projection extending in a radial inward direction from the pour channel, from a location spaced from the distal end of the pour spout and extending across the pour channel whereby the projection will prevent flow through the pour channel at a cut-off angle of tilt of the container wherein the contents would continue flow through the pour channel at the cut-off angle in the absence of the cut-off projection, and wherein the contents will flow through the pour channel over the cut-off projection at angles greater than the cut-off angle.

10. The molded pour spout of claim 9 wherein the pour spout is an integral molded neck finish of the container.

11. The molded pour spout of claim 9 further including an annular wall defining a drain back channel formed adjacent and in a radial outward location from the pour spout, and further including a drain back opening.

12. The molded pour spout of claim 9 further including external closure attachment threads on the pour spout.

13. The molded pour spout of claim 9 wherein the pour spout includes a substantially vertical portion above the cut-off projection.

14. The molded pour spout of claim 9 wherein an upper surface of the cut-off projection is angled relative to horizontal when the container is in a normal up-right resting position, whereby material above the cut-off as the container is placed into the resting position can flow back into the container.

15. The molded pour spout of claim 9 wherein the cut-off projection extends into the pour channel to a height that is greater than or equal to the thickness of the pour spout and less than or equal to the width of the pour channel.

16. A one-piece, injection molded pour spout fitment for attachment to a neck finish of a container comprising:
An annular skirt having internal attaching threads for coupling the fitment to a neck finish of a container;
At least a partially tapered upwardly extending pour spout coupled to the annular skirt, wherein the pour spout defines a pour channel on one side of the pour spout, wherein the pour channel is in fluid communication with the container when the fitment is attached thereto to allow for dispensing of the contents of the container through tilting of the container whereby the contents flow through the pour channel; and
An internal, flow cut-off projection extending in a radial inward direction from the pour channel, from a location spaced from the distal end of the pour spout and extending across the pour channel whereby the projection can selectively prevent flow through the pour channel, wherein an upper surface of the cut-off projection is angled relative to horizontal when the container is in a normal up-right resting position, whereby material above the cut-off as the container is placed into the resting position can flow back into the container.

17. The one-piece injection molded pour spout fitment of claim 16 further including an annular wall defining a drain back channel formed adjacent and in a radial outward location from the pour spout, and further including a drain back opening.

18. The one-piece injection molded pour spout fitment of claim 16 further including external closure attachment threads on the pour spout.

19. The one-piece injection molded pour spout fitment of claim 16 wherein the pour spout includes a substantially vertical portion above the cut-off projection.

20. The one-piece injection molded pour spout fitment of claim 16 wherein the cut-off projection extends into the pour channel to a height that is greater than or equal to the thickness of the pour spout and less than or equal to the width of the pour channel.
